(19) United States
(12) Patent Application Publication
(10) Pub. No.: US 2007/0214679 A1
(43) Pub. Date: Sep. 20, 2007

(54) Thermal impingement apparatus

(76) Inventor: Robert O. Brandt JR., Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 11/378,587

(22) Filed: Mar. 17, 2006

(51) Int. Cl. F26B 13/00

(52) U.S. Cl. 34/638; 34/611

(57) ABSTRACT

A thermal impingement apparatus quickly heats or cools food products and other items carried on an air permeable conveyor. A first air return chamber is spaced above the conveyor and a second return chamber is spaced beneath the conveyor, the return chambers having walls toward the conveyor that include a plurality of holes of a given dimension. A first plenum is opposite the first return chamber from the conveyor and a second plenum is opposite the second return chamber from the conveyor. A plurality of impingement nozzles extend from the plenums through the return chamber holes toward the conveyor. The cross-sections of the nozzles are smaller than the holes, creating return openings between the nozzles and the hole edges. An air conveyance means forces heated or cooled air from the plenums through the nozzles toward the conveyor and return air through the air return openings back to the plenums.

### BACKGROUND OF THE INVENTION

(1) Field of the Invention

The present invention relates to an impingement apparatus for rapidly heating or cooling items supported on a conveyor or other moving surface with heated or cooled air, and in particular to an impingement apparatus with provision for recycling air from the treatment zone with minimal turbulence.

(2) Description of the Prior Art

Impingement thermal treatment apparatus, the term “thermal treatment” being used herein to encompass heating or cooling with a gas, in particular air, having a temperature different from the temperature of the product being treated, is used in various manufacturing processes to rapidly raise or lower the temperature of the products being manufactured. An example of the use of impingement thermal treatment is in the food industry, where food products such as baked goods are rapidly cooled prior to packaging.

A typical impingement apparatus is comprised of a conveyor to move the subject products along a horizontal pathway and a plurality of impingement ports directed toward at least one surface of the conveyor. Heated or cooled air or other suitable gas is forced through the ports and against the subject products. Normally, the ports will be mounted within a tunnel housing that encloses a portion of the conveyor, with the conveyor projecting from the front and back of the tunnel housing through product inlets and outlets.

While air that has impinged upon the products, i.e., “spent” gas, may be exhausted from the treatment zone, i.e., the zone where the air impinges on the products supported on the conveyor, into the surrounding atmosphere or exhaust the gas to a remote location, most systems provide for a means to recycle the gas from the product treatment zone through a temperature adjustment device and back to the discharge ports. Often this exhaust mechanism utilizes one or more discharge ports leading from the treatment zone.

The objective of the air withdrawal system is to effectively exhaust air from the treatment zone without creating significant turbulence or otherwise interfering with the air flow from the discharge ports. Any disruption of air flow onto the subject products minimizes heat transfer, and thereby the ability of the air streams to heat or cool the products. While the prior art has described impingement apparatus with return air mechanisms directed to the minimization of turbulence and disruption in the treatment zone, there is still a need for further improvements in this area.

### SUMMARY OF THE INVENTION

The present invention is directed to an improved impingement apparatus for heating or cooling products on a conveyor or other moving surface, which includes means for exhausting air from the product treatment zone with minimal disruption of incoming air flow.

More specifically, the present invention is comprised of a conveyor for moving subject products along a pathway, a plurality of air discharge nozzles directed toward at least one surface of the conveyor, and an air conveyance means to force air through the nozzles onto the conveyor surface and withdraw air from the product treatment zone. While there are limited instances in which room temperature air may be used to cool or heat the subject products, the air will normally be heated or cooled to a temperature that is significantly different from that of the subject products as they enter the treatment zone.

Therefore, the apparatus of the present invention will normally also include an air temperature adjustment means to raise or lower the air temperature, with the air being channeled through the temperature adjustment means before being discharged from the distal ends of the discharge nozzles. The term “temperature adjustment means” is intended to encompass a wide range of heating or cooling devices, such as devices including resistance heating elements and refrigeration devices.

In order to achieve the minimal turbulence conditions of the present invention, the air nozzles extend through holes in a plate forming a wall spaced from the conveyor surface, with the holes having a greater cross-sectional area than the cross-section of the nozzles. As a result of the size difference, an exhaust opening is created between the outer wall of each nozzle and the continuous edge of the hole through which air can be exhausted from the treatment zone. Thus, air can be exhausted immediately adjacent the air discharge nozzle without crossing over into the area where air from another nozzle is being discharged. Turbulence and interference is thereby avoided.

In a preferred embodiment of the invention, the nozzles are tubular nozzles with a circular cross-section, while the plate holes also have a circular cross-section. It is also within the scope of the invention, however, for the nozzles and holes to have other cross-sections, such as oval or rectangular cross-sections. Preferably, the nozzles and holes have the same cross-sections with different dimensions. It is also preferred that the nozzles are centrally positioned in the holes, i.e., axially aligned with the holes, so that the continuous hole edges are equidistant from the nozzles on all sides. Where the nozzles and holes are of a circular cross-section, the diameter of the cross-section of said holes may be from about 1.5 to about 2.0 times the diameter of said nozzles, resulting in an annular exhaust opening between the nozzle and the hole edge. Circular holes will normally have a diameter of from about 0.25 to about 2.5 inches.

Preferably, the cross-sectional area of the return opening is about 1.5 to 2.5 times the cross-sectional area of the nozzle opening. While the return air opening may all be of the same size, it is also within the scope of the invention to make the return openings of different sizes. For example, the inner return air openings may be of a greater diameter than the outer return air openings to balance the air flow.

The plate may form a part of an air return chamber, with the plate wall being parallel to the surface of the conveyor. Air can then be drawn into the return chamber through the air exhaust openings and from the chamber back to the discharge nozzles. The discharge nozzles preferably extend through the return chamber from a plenum that is positioned opposite the return chamber from the conveyor, with the distal ends of the nozzles projecting beyond the plate. In this construction, an air conveyance means, e.g., a fan, is positioned between the air return chamber and the plenum. The air temperature adjustment means is also positioned between the return chamber and plenum, and preferably between the return chamber and the air conveyance means. Suitable conduits connect the air return chamber, plenum, air conveyance means, and temperature adjustment means.

In addition to a solid conveyor with a return chamber on a single side, the present invention also contemplates the use of an air permeable conveyor, e.g. a wire mesh conveyor, with air being discharged against both the upper and lower surfaces of the conveyor and the upper and lower surfaces of the subject products. Thus, the impingement apparatus may include a tunnel housing; a conveyor having upper and lower surfaces extending through the housing, and air recycling assemblies above and beneath the tunnel housing.

As used herein, the “air recycling assembly” comprises an air return chamber, a plenum with nozzles projecting through the air return chamber, and a conduit extending from the chamber to the plenum through an air temperature adjustment means and an air conveyance means. In the embodiment of the invention using an air permeable conveyor, a first air recycling assembly is spaced above the conveyor and a second air recycling assembly is spaced beneath the conveyor.

The first recycling assembly includes a first air return chamber having a lower wall positioned above and parallel to the conveyor. The first chamber lower wall includes a plurality of arrayed holes having cross-sections of a given dimension. A first plenum is positioned above the first air return chamber, with a first plurality of air discharge nozzles extending from the first plenum through the first air return chamber and beyond the lower wall toward the upper surface of the conveyor. The first discharge nozzles extend through the holes in the lower wall and are preferably axially aligned with the holes so that annular exhaust openings are formed between the continuous hole edges and the outer walls of the nozzles.

Similarly, the second air recycling assembly spaced beneath the conveyor return chamber includes a second air return chamber having an upper wall positioned beneath and parallel to the conveyor. The upper wall also includes a plurality of arrayed holes having cross-sections of a given dimension. A second plenum is positioned beneath the second air return chamber, with a second plurality of air discharge nozzles extending from the second plenum through the second air return chamber and beyond the upper wall toward the lower surface of the conveyor. The second discharge nozzles extend through the holes in the upper wall and are preferably axially aligned with the holes so that annular exhaust openings are formed between the continuous opening edges and the outer walls of the second nozzles.

A first return conduit extends from the first chamber to the first plenum, and a second return conduit extends from the second chamber to the second plenum. At least one air conveyance means is provided to convey air through the conduits. A common air conveyance means may be used for both assemblies, or separate air conveyance means may be provided for each assembly. Also, at least one air temperature adjustment means is provided to heat or cool air conveyed through the conduits. The air from both assemblies may be channeled through a common air temperature adjustment means or through separate air temperature adjustment means.

In operation of the above embodiment of the invention, a plurality of subject products, e.g., freshly prepared food items, are carried on the air permeable conveyor from an inlet end through to a discharge end, and through an impingement tunnel surrounding a portion of the conveyor. Air is discharged against the upper and lower surfaces of the conveyor from the discharge nozzles arrayed above and below the conveyor.

As the air is discharged onto the subject products, cooling or heating the products depending on the temperature differential, air is simultaneously withdrawn from the treatment zone through the exhaust openings. The air drawn through each exhaust opening is drawn from the area immediately surrounding the discharge nozzle. As a result, no significant air flow across the discharge pathway of another nozzle is produced. Therefore, turbulence and interference with the discharge air flow is minimized.

Air drawn into the return chambers is carried through a temperature adjustment means where it is heated or cooled as appropriate and again forced from the discharge nozzles. Thus, products carried on the conveyor are continuously subjected to a plurality of jets of air, cooling or heating the products. For example, freshly baked goods entering the tunnel at an elevated temperature exit the tunnel at a reduced temperature permitting packaging.

### BRIEF DESCRIPTION OF THE DRAWINGS

FIG. 1 is a perspective view of sectional side view of the impingement apparatus.

FIG. 2 is a sectional end view of one embodiment of the impingement apparatus.

FIG. 3 is a sectional end view of another embodiment of the impingement apparatus.

FIG. 4 is a plan view of an upper air return plate.

FIG. 5 is a plan view of a lower air return plate.

FIG. 6 is a detail plan view of an air exhaust opening and nozzle.

FIG. 7 is a detail sectional side view of an air exhaust opening and nozzle.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

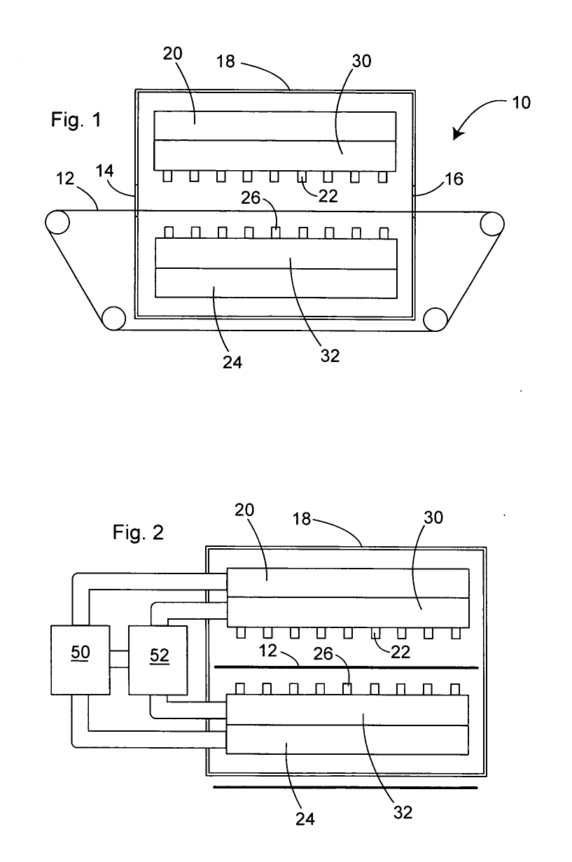

As best seen in FIGS. 1-3, a preferred embodiment of the impingement apparatus, generally 10, is comprised of a continuous conveyor 12. For purposes of the present description, reference to “conveyor 12” refers to the section of the conveyor upon which the products to be treated are conveyed. Conveyor 12 passes through inlet 14 and outlet 16 of a tunnel chamber 18. A first plenum 20 with downwardly projecting discharge nozzles 22 is mounted above conveyor 12, and a second plenum 24 with upwardly projecting discharge nozzles 26 is mounted beneath conveyor 12.

Nozzles 22 extend through and project beyond the lower surface of air return chamber 30 mounted beneath plenum 20. Nozzles 26 extend through and project beyond the upper surface of air return chamber 32 mounted above plenum 24. The lower wall 34 of air return chamber 30 is shown in FIG. 4, while upper wall 36 of chamber 32, identical in construction to wall 34, is illustrated in FIG. 5. Wall 34 includes an array of holes 38, while wall 36 includes an array of identical holes 40. Nozzles 22 project through, and are axially aligned with holes 38 in plate 34 leaving annular exhaust openings 42 between nozzles 22 and the continuous edges of holes 38. Similarly, nozzles 26 project through, and are axially aligned with holes 40 in plate 36 leaving annular exhaust openings 44 between nozzles 26 and the continuous edges of holes 40.

Plenums 20 and 24 and chambers 30 and 32 are in communication with an air conveyance means to convey air from housings 30 and 32 to plenums 20 and 24, and a temperature adjustment means to adjust the temperature of the returned air as appropriate. In the embodiment shown in FIG. 2, plenums 20 and 24 and chambers 30 and 32 are in communication with a common air conveyance means 50 and a common temperature adjustment means 52.

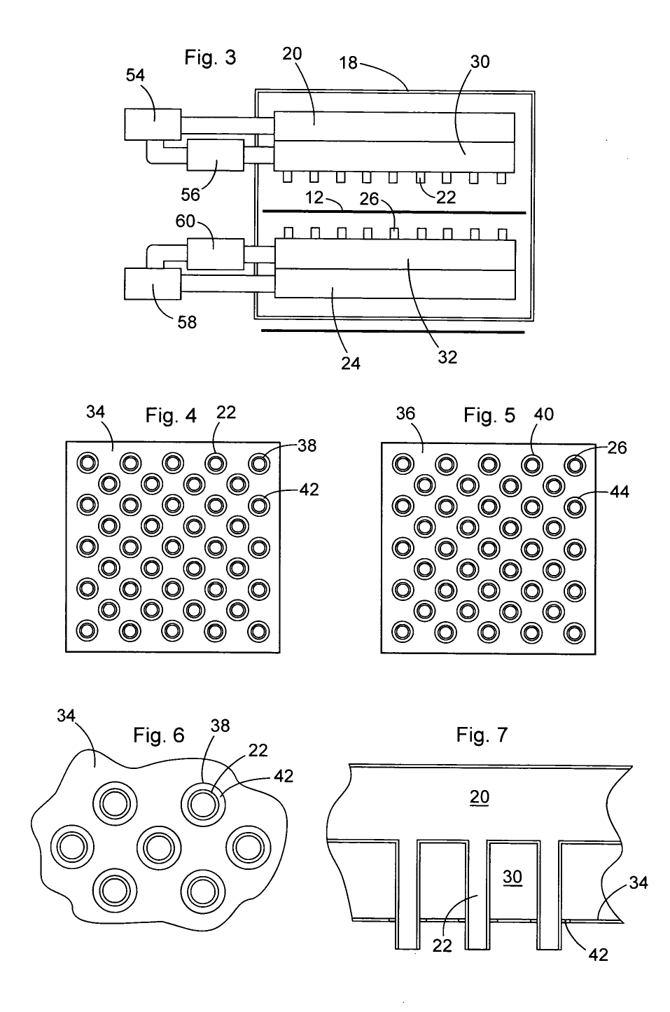

In the alternative embodiment illustrated in FIG. 3, plenum 20 and return chamber 30 are in communication through air conveyance means 54 and temperature adjustment means 56, while plenum 24 and return chamber 32 communicate through air conveyance means 58 and temperature adjustment means 60.

In operation, subject products, e.g., freshly baked food items, not shown, are carried along conveyor 12 through tunnel 18. Air under a pressure normally of from about 0.025 to about 1.0 psi is forced through nozzles 22 against the upper surface of the subject products, and from nozzles 26 through conveyor 12 against the lower surface of the subject products. Simultaneously, air is withdrawn from the area beneath return housing 30 through the annular spaces 42 around nozzles 22 and the edges of holes 38 in plate 34 into chamber 30, and from the area above return chamber 32 through the annular spaces 44 around nozzles 26 and the edges of holes 40 in plate 36 into chamber 32. Air is then conveyed by air conveyance means 50 through temperature adjustment means 52 in the embodiment shown in FIG. 2 back to plenums 20 and 24 from which the temperature adjusted air is again discharged. In the embodiment shown in FIG. 3, air from chamber 30 is conveyed through temperature adjustment means 56 by air conveyance means 54 back to plenum 20, while air is conveyed from chamber 32 back to plenum 24 through temperature adjustment means 60 by air conveyance means 58.

Since discharged air is withdrawn from the treatment zone through exhaust openings immediately adjacent the nozzles from which the air is discharged, there is no interruption of the flow from immediately adjacent discharge nozzles. As a result, there is an improved and more efficient temperature transfer.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A thermal impingement apparatus comprising:
a) a conveyor;
b) an air return chamber spaced from said conveyor, said return housing having a wall toward said conveyor that includes a plurality of holes having continuous edges and cross-sections of a given dimension;
c) a plurality of impingement nozzles extending through said return chamber holes, said nozzles having a cross-section of a dimension less than said given dimension, whereby air return openings are created between said nozzles and the edges of said holes; and
d) air conveyance means to force air toward said conveyor through said nozzles and withdraw air through said air return openings.

2. The apparatus of claim 1, further including a tunnel housing surrounding a portion of said conveyor.

3. The apparatus of claim 1, further including an air temperature adjustment means.

4. The apparatus of claim 1, wherein said holes are circular with a given diameter and said nozzles have a circular cross-section with a diameter less than said given diameter.

5. The apparatus of claim 1, further including a plenum opposite said air return housing from said conveyor, said nozzles extending from said plenum through said holes.

6. The apparatus of claim 5, further including air conveyance means to force air from said plenum through said nozzles toward said conveyor and return air through said return air chamber to said plenum, said air being drawn into said chamber through said air return openings.

7. The apparatus of claim 1, wherein said nozzles are axially aligned in said holes.

8. The apparatus of claim 1, wherein holes and said nozzles have circular cross-sections, the diameter of the cross-section of said holes being from about 1.5 to about 5 times the diameter of said nozzles.

9. The apparatus of claim 1, wherein said conveyor is air permeable.

10. A thermal impingement apparatus comprising:
a) a tunnel housing;
b) a conveyor having upper and lower surfaces extending through said housing;
c) a first air return chamber spaced from one of said conveyor surfaces, said return chamber having a wall toward one of said conveyor surfaces that includes a plurality of holes having continuous edges and a given dimension;
d) a first plenum opposite said return chamber from said conveyor;
e) a plurality of impingement nozzles extending from said first plenum through said first return chamber holes, said jets having an outer cross-sectional dimension less than said given dimension, whereby air return openings are created between said nozzles and said hole edges;
f) air temperature adjustment means; and
g) air conveyance means to force air from said first plenum through said nozzles toward said conveyor and return air through said first return air chamber and said temperature adjustment means to said first plenum, said air being drawn into said return chamber through said air return openings.

11. The apparatus of claim 10, further including means to direct air against the other of said conveyor surfaces.

12. The apparatus of claim 10, wherein said air temperature adjustment means is an air cooling means.

13. The apparatus of claim 10, wherein said air temperature adjustment means is an air heating means.

14. The apparatus of claim 10, wherein said nozzles are axially aligned in said holes.

15. The apparatus of claim 10, wherein holes and said nozzles have circular cross-sections, the diameter of the cross-section of said holes being from about 1.5 to about 5 times the diameter of said nozzles.

16. A thermal impingement apparatus comprising:
a) a tunnel housing;
b) a conveyor having upper and lower surfaces extending through said housing;
c) a first air return chamber spaced above said conveyor and a second return chamber spaced beneath said conveyor, said return chambers having walls toward said conveyor that include a plurality of holes of a given dimension;
d) a first plenum opposite said first return chamber from said conveyor and a second plenum opposite said second return chamber from said conveyor;
e) a plurality of impingement nozzles extending from said first plenum through said first return chamber holes, and a plurality of impingement nozzles extending from said second plenum through said second return chamber holes, said nozzles having an outer cross-sectional dimension less than said given dimension, whereby air return openings are created between said nozzles and said openings;
f) air temperature adjustment means; and
g) air conveyance means to force air from said plenums through said nozzles toward said conveyor and return air through said return air chambers and said temperature adjustment means to said plenums, said air being drawn into said return chambers through said air return openings.

17. The apparatus of claim 16, wherein said holes have a diameter of from about 1.5 to about 5 times the outer diameter of said nozzles.

18. The apparatus of claim 16, wherein said conveyor is a wire mesh conveyor.

19. The apparatus of claim 16, wherein said air return openings are annular openings.

20. The apparatus of claim 16, wherein said first and second chambers are in communication with said first and second plenums through a common temperature adjustment means.
